(19) United States
(12) Patent Application Publication
(10) Pub. No.: US 2014/0376428 A1
(43) Pub. Date: Dec. 25, 2014

(54) MULTI-FREQUENCY RANGE PROCESSING FOR RF FRONT END

(71) Applicant: QUALCOMM Incorporated, San Diego, CA (US)

(72) Inventors: Sumit Verma, San Diego, CA (US); Guining Shi, San Diego, CA (US); Ryan Scott C. Spring, San Diego, CA (US); Robert Lloyd Robinett, San Diego, CA (US)

(73) Assignee: QUALCOMM Incorporated, San Diego, CA (US)

(21) Appl. No.: 14/051,034

(22) Filed: Oct. 10, 2013

Related U.S. Application Data
(60) Provisional application No. 61/837,502, filed on Jun. 20, 2013.
(60) Provisional application No. 61/838,769, filed on Jun. 24, 2013.

(51) Int. Cl. H04L 5/08; H04J 1/04

(52) U.S. Cl. CPC H04L 5/08; H04J 1/04
USPC 370/297; 370/343

(57) ABSTRACT

Techniques for supporting multi-frequency range signal processing for a wireless device. In an aspect, a first antenna is provided to support first and third frequency ranges. A second antenna is separately provided to support a second frequency range, wherein the second is between the first and third frequency ranges. In other aspects, the second antenna can further support a fourth frequency range higher than the third frequency range. Other frequency range combinations, dual antenna aspects, and carrier aggregation features are further disclosed herein.

### RELATED APPLICATIONS

This application claims the benefit of U.S. Provisional Patent Application No. 61/837,502, entitled “Dual Range Antennas for Carrier Aggregation,” filed Jun. 20, 2013, and U.S. Provisional Patent Application No. 61/838,769, entitled “Dual Range Antennas for Carrier Aggregation,” filed Jun. 24, 2013, the contents of which are hereby incorporated by reference in their entirety.

### BACKGROUND

1. Field

The disclosure relates to multi frequency range processing for radio-frequency (RF) circuits.

2. Background

State-of-the-art wireless devices are commonly designed to support radio processing for multiple frequency ranges. For example, to support a carrier aggregation (CA) feature for the Long-Term Evolution (LTE) standard, multiple carriers across multiple frequency ranges may be simultaneously received and processed by a wireless device. In this case, frequency selection and isolation techniques should be applied, to ensure that signals of one frequency range do not interfere with those of another.

Prior art techniques for accommodating carrier aggregation (CA) include, e.g., providing frequency separation elements such as diplexers or even quadplexers to isolate the signals of the multiple frequency ranges from each other. For frequency ranges that are relatively close, it may be costly to design such frequency separation elements to isolate the signals with sufficiently high quality factor (Q).

It would thus be desirable to provide techniques for relaxing the constraints placed on wireless devices accommodating multiple frequency bands, and for accommodating the requirements of state-of-the-art wireless standards such as LTE.

### BRIEF DESCRIPTION OF THE DRAWINGS

FIG. 1 illustrates a block diagram of a design of a prior art wireless communication device in which the techniques of the present disclosure may be implemented.

FIG. 2 illustrates a frequency spectrum showing a generalized allocation of multiple radio frequency ranges.

FIG. 3 illustrates a prior art implementation of an RF front end in which one antenna is shared amongst circuitry for processing multiple frequency ranges.

FIG. 4 illustrates an exemplary embodiment of an RF front end for simultaneously processing multiple frequency ranges according to the present disclosure.

FIG. 5 illustrates an exemplary embodiment of an RF front end wherein frequency selection block accommodates a single range R2.

FIG. 6 further illustrates an exemplary embodiment of an RF front end incorporating specific instances of range-specific circuitry.

FIG. 7 illustrates an exemplary embodiment of an RF front end, wherein a frequency selection block accommodates both R2 and R4.

FIG. 8 illustrates an exemplary embodiment of an RF front end incorporating specific instances of range-specific circuitry.

FIG. 9 illustrates an alternative exemplary embodiment of an RF front end wherein a frequency selection block accommodates three ranges R0, R2, and R4.

FIG. 10 illustrates an exemplary embodiment of a wireless device implementing the techniques of the present disclosure.

FIG. 11 illustrates an exemplary embodiment of a method according to the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The detailed description set forth below in connection with the appended drawings is intended as a description of exemplary aspects of the invention and is not intended to represent the only exemplary aspects in which the invention can be practiced. The term “exemplary” used throughout this description means “serving as an example, instance, or illustration,” and should not necessarily be construed as preferred or advantageous over other exemplary aspects. The detailed description includes specific details for the purpose of providing a thorough understanding of the exemplary aspects of the invention. It will be apparent to those skilled in the art that the exemplary aspects of the invention may be practiced without these specific details. In some instances, well-known structures and devices are shown in block diagram form in order to avoid obscuring the novelty of the exemplary aspects presented herein. In this specification and in the claims, the terms “module” and “block” may be used interchangeably to denote an entity configured to perform the operations described. It will be appreciated that similarly numbered elements throughout the figures hereinbelow may generally correspond to elements performing the same functionality, and accordingly, the description of such repeated elements may be omitted in certain instances.

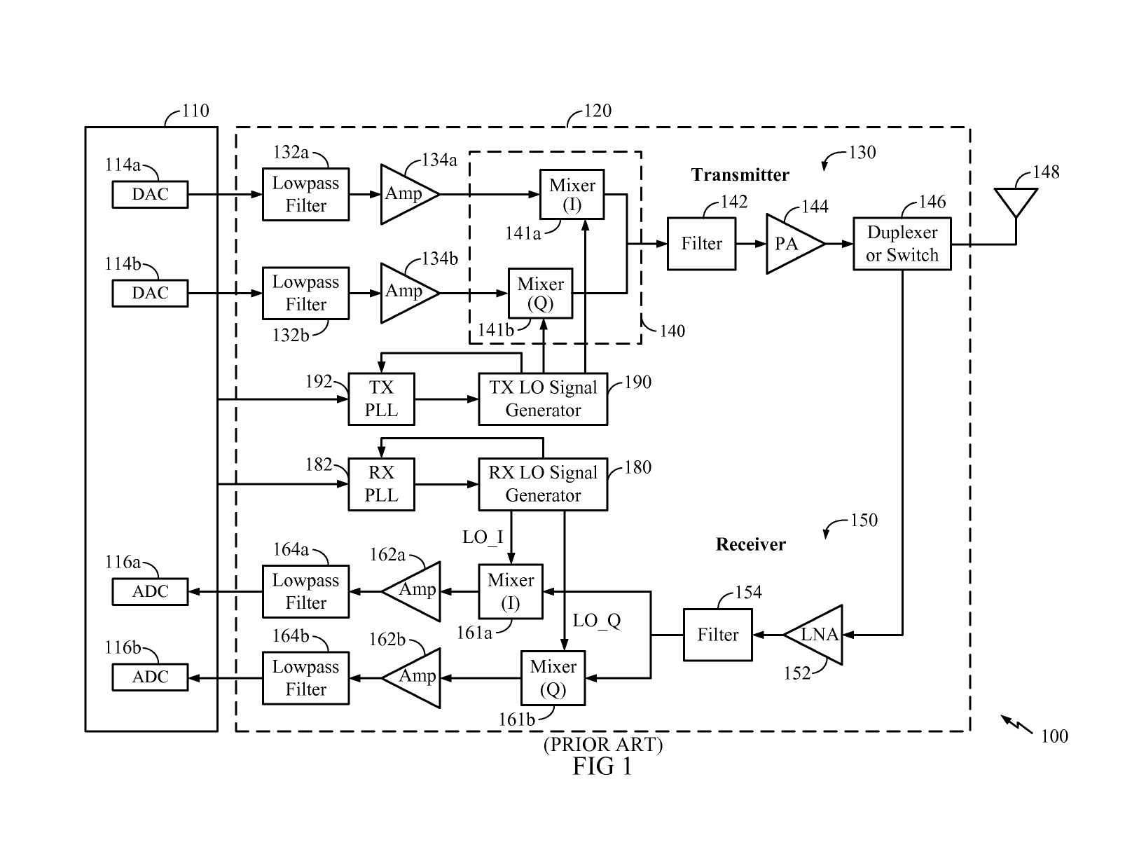

FIG. 1 illustrates a block diagram of a design of a prior art wireless communication device 100 in which the techniques of the present disclosure may be implemented. FIG. 1 shows an example transceiver design. In general, the conditioning of the signals in a transmitter and a receiver may be performed by one or more stages of amplifier, filter, upconverter, downconverter, etc. These circuit blocks may be arranged differently from the configuration shown in FIG. 1. Furthermore, other circuit blocks not shown in FIG. 1 may also be used to condition the signals in the transmitter and receiver. Unless otherwise noted, any signal in FIG. 1, or any other figure in the drawings, may be either single-ended or differential. Some circuit blocks in FIG. 1 may also be omitted.

In the design shown in FIG. 1, wireless device 100 includes a transceiver 120 and a data processor 110. The data processor 110 may include a memory (not shown) to store data and program codes. Transceiver 120 includes a transmitter 130 and a receiver 150 that support bi-directional communication. In general, wireless device 100 may include any number of transmitters and/or receivers for any number of communication systems and frequency bands. All or a portion of transceiver 120 may be implemented on one or more analog integrated circuits (ICs), RF ICs (RFICs), mixed-signal ICs, etc.

A transmitter or a receiver may be implemented with a super-heterodyne architecture or a direct-conversion architecture. In the super-heterodyne architecture, a signal is frequency-converted between radio frequency (RF) and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the design shown in FIG. 1, transmitter 130 and receiver 150 are implemented with the direct-conversion architecture.

In the transmit path, data processor 110 processes data to be transmitted and provides I and Q analog output signals to transmitter 130. In the exemplary embodiment shown, the data processor 110 includes digital-to-analog-converters (DAC's) 114a and 114b for converting digital signals generated by the data processor 110 into the I and Q analog output signals, e.g., I and Q output currents, for further processing.

Within transmitter 130, lowpass filters 132a and 132b filter the I and Q analog output signals, respectively, to remove undesired images caused by the prior digital-to-analog conversion. Amplifiers (Amp) 134a and 134b amplify the signals from lowpass filters 132a and 132b, respectively, and provide I and Q baseband signals. An upconverter 140 upconverts the I and Q baseband signals with I and Q transmit (TX) local oscillator (LO) signals from a TX LO signal generator 190 and provides an upconverted signal. A filter 142 filters the upconverted signal to remove undesired images caused by the frequency upconversion as well as noise in a receive frequency band. A power amplifier (PA) 144 amplifies the signal from filter 142 to obtain the desired output power level and provides a transmit RF signal. The transmit RF signal is routed through a duplexer or switch 146 and transmitted via an antenna 148.

In the receive path, antenna 148 receives signals transmitted by base stations and provides a received RF signal, which is routed through duplexer or switch 146 and provided to a low noise amplifier (LNA) 152. The duplexer 146 is designed to operate with a specific RX-to-TX duplexer frequency separation, such that RX signals are isolated from TX signals. The received RF signal is amplified by LNA 152 and filtered by a filter 154 to obtain a desired RF input signal. Downconversion mixers 161a and 161b mix the output of filter 154 with I and Q receive (RX) LO signals (i.e., LO_I and LO_Q) from an RX LO signal generator 180 to generate I and Q baseband signals. The I and Q baseband signals are amplified by amplifiers 162a and 162b and further filtered by lowpass filters 164a and 164b to obtain I and Q analog input signals, which are provided to data processor 110. In the exemplary embodiment shown, the data processor 110 includes analog-to-digital-converters (ADC's) 116a and 116b for converting the analog input signals into digital signals to be further processed by the data processor 110.

In FIG. 1, TX LO signal generator 190 generates the I and Q TX LO signals used for frequency upconversion, while RX LO signal generator 180 generates the I and Q RX LO signals used for frequency downconversion. Each LO signal is a periodic signal with a particular fundamental frequency. A PLL 192 receives timing information from data processor 110 and generates a control signal used to adjust the frequency and/or phase of the TX LO signals from LO signal generator 190. Similarly, a PLL 182 receives timing information from data processor 110 and generates a control signal used to adjust the frequency and/or phase of the RX LO signals from LO signal generator 180.

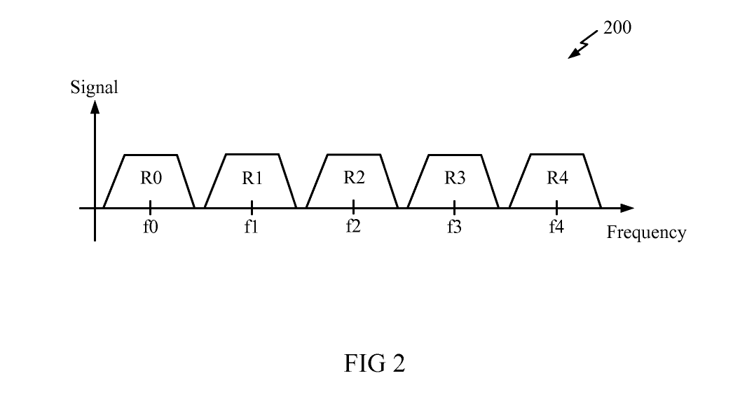

State-of-the-art wireless devices may support simultaneous processing of multiple radio frequency ranges, e.g., as may be required to implement a carrier aggregation (CA) feature of the Long-Term Evolution (LTE) wireless standard. FIG. 2 illustrates a frequency spectrum 200 showing a generalized allocation of multiple radio frequency ranges. Note FIG. 2 is shown for illustrative purposes only, and is not meant to limit the scope of the present disclosure to any particular frequency spectrum or allocation of frequency ranges shown. For example, spectrum 200 is not meant to limit the scope of the present disclosure to any particular number of frequency ranges. It will be appreciated that particular exemplary embodiments of the present disclosure may accommodate fewer or greater than the number of frequency ranges illustratively shown.

In FIG. 2, spectrum 200 includes five frequency ranges R0, R1, R2, R3, and R4, with labeled frequencies f0, f1, f2, f3, and f4 corresponding to representative frequencies of the respective ranges. In the particular spectrum 200 shown, the representative frequencies are related to each other such that f0<f1<f2<f3<f4, e.g., frequency f0 is lower than frequency f1, which is lower than frequency f2, etc. Note while the upper and lower frequency boundaries of each frequency range shown in FIG. 2 are such that the frequency ranges do not overlap with each other, it will be appreciated that techniques of the present disclosure may readily be applied to systems wherein one or more frequency ranges do overlap with each other. Furthermore, the dimensions of the frequency ranges shown in FIG. 2 are not necessarily drawn to scale, and are not meant to suggest any particular bandwidth of a frequency range relative to another.

In an exemplary embodiment, R1 may correspond to, e.g., a 699-960 MHz range (or “low range”). R2 may correspond to, e.g., a 1427-1511 MHz range (or “mid range”). R3 may correspond to, e.g., a 1710-2200 MHz range (or “high range”). R4 may correspond to, e.g., a 2300-2690 MHz range (or a “super high range”). Note these correspondences are described for illustrative purposes only, and are not meant to limit the scope of the present disclosure to any particular frequency ranges.

To support simultaneous processing on two or more of the ranges R0-R4, one antenna for each frequency range may be provided in a wireless device, and each antenna may be coupled to a corresponding circuitry block for processing that frequency range. While providing one antenna and/or circuitry block for one frequency range may be a straightforward design option, it is desirable to reduce the size of modern wireless devices by reducing the area occupied by the antennas. Accordingly, it would be desirable to share one or more antennas amongst the multiple frequency ranges.

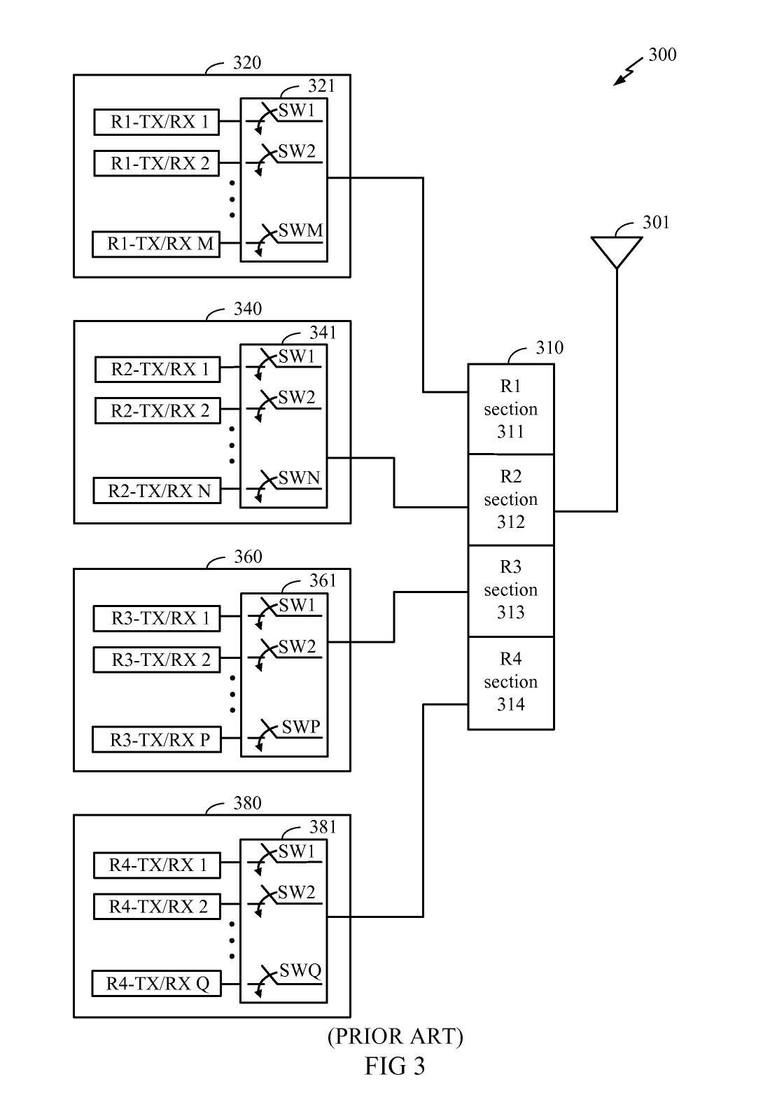

FIG. 3 illustrates a prior art implementation 300 of an RF front end in which one antenna is shared amongst circuitry for processing multiple frequency ranges. Note while the specific implementation 300 of the RF front end shown does not accommodate R0, one of ordinary skill in the art may readily adapt the techniques described hereinbelow to further accommodate R0.

In FIG. 3, RF front end 300 includes an antenna 301 coupled to a quadplexer 310, which accommodates four frequency ranges R1, R2, R3, R4 using range-selective sections 311, 312, 313, 314, respectively. Each range-selective section of quadplexer 310 may, e.g., pass through signals within the pass-band of such range-selective section, while rejecting signals outside of such pass-band. Accordingly, in the receive direction, the quadplexer 310 may be understood to separate (e.g., de-multiplex) signals received from antenna 301 depending on the frequency range, and output the de-multiplexed signal to an output node of the appropriate range-selective section 311, 312, 313, or 314. Similarly, in the transmit direction, the quadplexer 310 may be understood to combine (e.g., multiplex) signals received from range-specific circuitry (further described hereinbelow) into one signal for transmission over antenna 301.

As shown in FIG. 3, each of range-selective sections 311, 312, 313, 314 is coupled to respective range-specific circuitry 320, 340, 360, 380 for processing range-specific signals. Range-specific circuitry 320, 340, 360, 380 includes multiple-throw switch modules 321, 341, 361, 381, respectively. For example, multiple-throw switch module 321 includes a plurality M of switches, e.g., SW1 through SWM, that selectively couple or decouple range-selective section 311 to a plurality of transceiver blocks for processing R1 signals, e.g., transceiver blocks R1-TX/RX 1 through R1-TX/RX M. In an implementation, each transceiver block may be designed to process a distinct frequency channel lying within each associated frequency range. For example, R1-TX/RX 1 may process a first frequency channel lying within frequency range R1, R1-TX/RX 2 may process a second frequency channel lying within frequency range R1, etc. It will be appreciated that the switch modules of the other range-specific circuitry 340, 360, 380 may perform similar functions as described hereinabove with reference to range-specific circuitry 320 for their corresponding frequency ranges.

It will be appreciated that any of the terms “channel,” “band,” “carrier,” etc., as used herein may denote a particular sub-division of a range-specific signal, e.g., along any of the dimensions of frequency, time, code, space, etc.

In an implementation, during typical operation of RF front end 300, one switch in each of switch modules 321, 341, 361, 381 may be closed, and the other switches associated with channels not being actively processed may be opened. In this manner, a unique transceiver block may effectively be selected to actively process a channel of each frequency range. For example, if R1-TX/RX 1 (e.g., the transceiver block associated with a first frequency channel lying within frequency range R1) is selected for active processing, then SW1 in switch module 321 may be closed, while the other switches of switch module 321, e.g., SW2 through SWM, may be opened. Similarly, switches of the other switch modules 341, 361, 381 may be selectively opened and closed to select particular channels of the other frequency ranges for active processing. In the RF front end 300 shown, the simultaneous processing of up to four channels, e.g., one channel for each frequency range, may thus be supported according to the scheme described hereinabove, e.g., to implement a carrier aggregation (CA) feature of the LTE standard.

In certain implementations of RF front end 300, if any of the frequency ranges R1, R2, R3, and R4, are relatively close to each other, it will be appreciated that the range-specific signals may be difficult to separate from each other using quadplexer 310. For example, if the frequency boundaries of R1 and R2 are relatively close, then separating R1 from R2 signals may require one or more filters with very high quality factor (Q) in the quadplexer 310, which may undesirably increase the cost of the design. Furthermore, if RF front end 300 simultaneously transmits and receives in two adjacent frequency ranges (e.g., TX on R1 and RX on R2), then a high-Q filter will be needed to filter out the relatively strong TX signal from an adjacent frequency range. In particular, prior art mobile wireless devices may lack sufficiently high Q filters and/or circuitry for processing the plurality of signal frequencies within each range R1 through R4, in which case transceiver linearity limitations may create harmonics and intermodulation products that interfere with the other frequency range receivers.

Furthermore, designing a single antenna 301 to simultaneously accommodate four frequency ranges R1, R2, R3, and R4 may require a very broadband response for the antenna, which may undesirably lower the antenna's efficiency as well as increase its physical dimensions. In particular, very broadband antennas can have lower efficiency depending on their physical size and design. Mobile handsets have a very limited volume, and this therefore restricts the size of the antenna. In many mobile wireless devices, the available volume may not be enough to keep the antenna efficiency constant as the frequency range increases from R1, R2 to R3, R4, and beyond.

It would thus be desirable to provide novel and effective techniques for efficiently processing multiple frequency ranges in a wireless device.

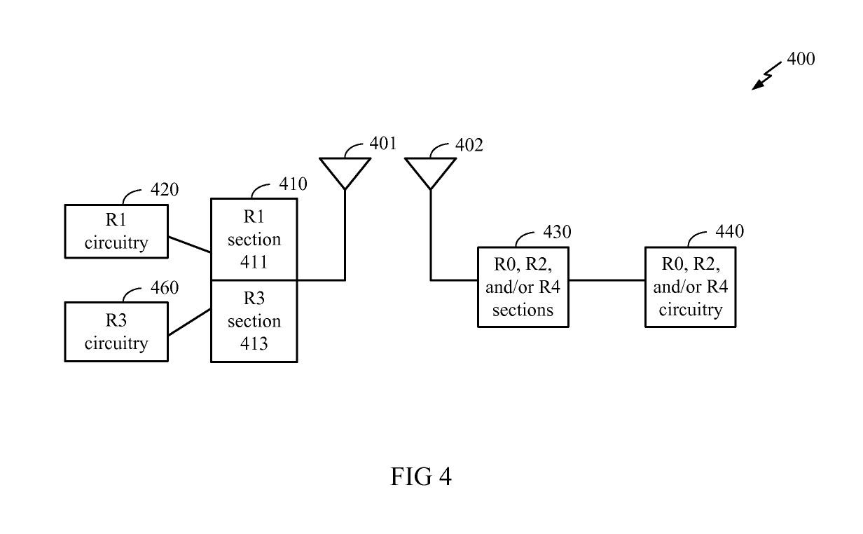

FIG. 4 illustrates an exemplary embodiment 400 of an RF front end for simultaneously processing multiple frequency ranges according to the present disclosure. Note FIG. 4 is shown for illustrative purposes only, and is not meant to limit the scope of the present disclosure to any particular exemplary embodiment shown.

In FIG. 4, an antenna 401 is coupled to a diplexer 410, which accommodates two frequency ranges R1, R3 using respective range-selective sections 411, 413. Sections 411 and 413 are coupled to R1-specific circuitry 420 and R3-specific circuitry 460, respectively. An antenna 402 is coupled to a frequency selection block 430, which may accommodate any or all of frequency ranges R0, R2, and R4. In particular, frequency selection block 430 may generally be designed to accommodate any of the following combinations of frequency ranges: 1) only R0, 2) only R2, 3) only R4, 4) R0 and R2, 5) R2 and R4, 6) R0 and R4, and 6) R0, R2, and R4. Frequency selection block 430 is coupled to range-specific circuitry 440.

For example, in an exemplary embodiment wherein antenna 402 accommodates only one range (e.g., only R0, only R2, or only R4), then block 430 may include a simple band-pass filter having a passband corresponding to the appropriate frequency range. Alternatively, in an exemplary embodiment wherein two ranges are accommodated (e.g., R0 and R2, or R2 and R4), then block 430 may include two range-selective sections (e.g., a single diplexer, not explicitly shown in FIG. 4), each section having a passband corresponding to one of the two frequency ranges. Alternatively, in an exemplary embodiment wherein three frequency ranges are accommodated (e.g., R0, R2, and R4), then block 430 may include three range-selective sections (not shown), each section having a passband corresponding to one of the three frequency ranges. Such an exemplary embodiment accommodating three frequency ranges may alternatively include two range-selective sections (not shown), wherein a first section has a passband corresponding to one of the three frequency ranges, while a second section has two passbands corresponding to the other two frequency ranges.

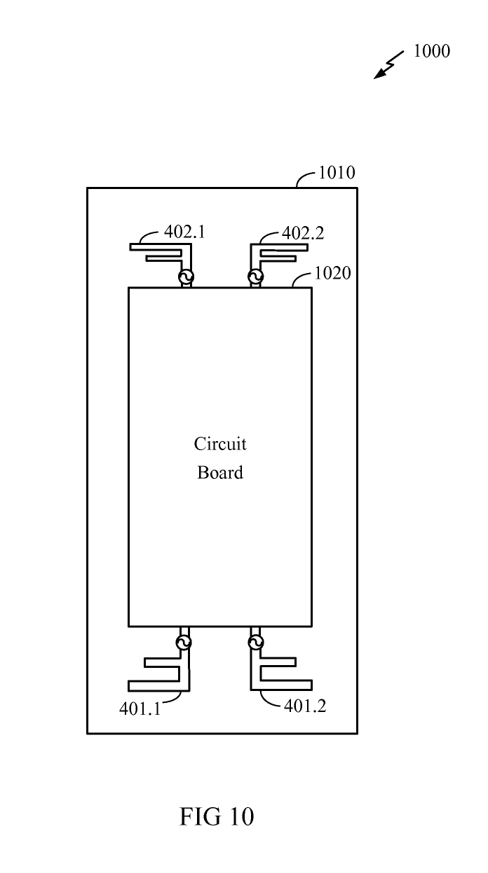

Note in alternative exemplary embodiments (not shown), multiple instances of each of antennas 401 and 402, along with corresponding circuitry, may be provided in a single wireless device, e.g., for spatial diversity. For example, a wireless device supporting the LTE standard may include four antennas implementing the functionality shown in FIG. 4, with two antennas each performing the function of antenna 401, and two antennas each performing the function of antenna 402. Furthermore, each of such antennas may be coupled to corresponding range-selection blocks and range-specific circuitry as shown in FIG. 4. Note one such illustrative exemplary embodiment is further described hereinbelow with reference to FIG. 10. Such alternative exemplary embodiments are contemplated to be within the scope of the present disclosure.

It will be appreciated that in certain alternative exemplary embodiments (not shown), one of ordinary skill in the art may readily modify the techniques herein to include one or more additional antennas to support one or more frequency ranges not specified herein. For example, an additional antenna (not illustrated in the figures) may readily be provided to accommodate a separate frequency range, e.g., a global positioning system (GPS) frequency range, not explicitly specified herein. Such alternative exemplary embodiments are contemplated to be within the scope of the present disclosure.

It will be appreciated that, in the exemplary embodiment 400, transmit (TX) signals from antenna 401 (e.g., associated with transmit signals and/or transmit harmonics from R1 and R3 transceiver circuitry) will be attenuated by an antenna-to-antenna isolation factor, prior to being received at antenna 402 as potential jammers. Conversely, the same effect applies to the reception at antenna 401 of potential jammers originating from the R2 transmit (TX) signals of antenna 402. In particular, if antennas 401 and 402 are separated by a distance d, then there will be a path loss Lp between antenna 401 and antenna 402 that depends on d. Furthermore, each antenna is expected to have a higher efficiency in the particular range it is designed to process. For example, antenna 401 for R1 and R3 may have an efficiency of −5 dB or better in R1 and R3, but antenna 401 may have a lower efficiency of, e.g., −15 dB in R2, corresponding to, e.g., a second harmonic of a transmission in R1. This efficiency difference between antennas effectively implements a filtering function for the respective frequency ranges based on the inherent characteristics of providing separate antennas.

In view of the above considerations, the total isolation will include the effects of path loss as well as the aforementioned filtering function. For example, the total attenuation of an R1 transmission at antenna 401 to reception at antenna 402 may include, e.g., 15 dB path loss, and 15 dB loss arising from the antenna efficiency differences. Thus the total attenuation would be at least 30 dB in this example. In contrast, prior art implementation 300 would need to provide an additional 30 dB cumulative attenuation in quadplexer 310 to achieve the same level of isolation, which would mandate very high-Q and thus expensive components. Accordingly, the design requirements for the filters in diplexer 410 and block 430, and/or range-specific circuitry 420, 460, 440, may be relaxed, allowing the antennas to be designed for even better efficiency.

In an exemplary embodiment, f1 may correspond to an LTE B28 TX signal at 740 MHz in R1, while f2 may correspond to a B11 RX downlink signal at 1480 MHz in R2. In such an exemplary embodiment, absent the techniques disclosed herein, a second harmonic of the LTE B1 TX signal may significantly interfere with the B7 RX downlink signal at antenna 402. However, by applying the techniques disclosed hereinabove, such interference will be attenuated by the aforementioned antenna-to-antenna isolation factor.

Furthermore, the techniques described herein advantageously eliminate potential intermodulation issues commonly encountered in multi-range radios. For example, if f3 corresponds to a B3 TX signal at 1820 MHz or B1 TX signal at 1950 MHz, then, due to the low efficiency of antenna 401 and antenna 402 at, e.g., 2*f3, then intermodulation products such as 2*f3−f1 or 2*f3−f2 are not expected to be significant at a receiver coupled to antenna 401 or antenna 402.

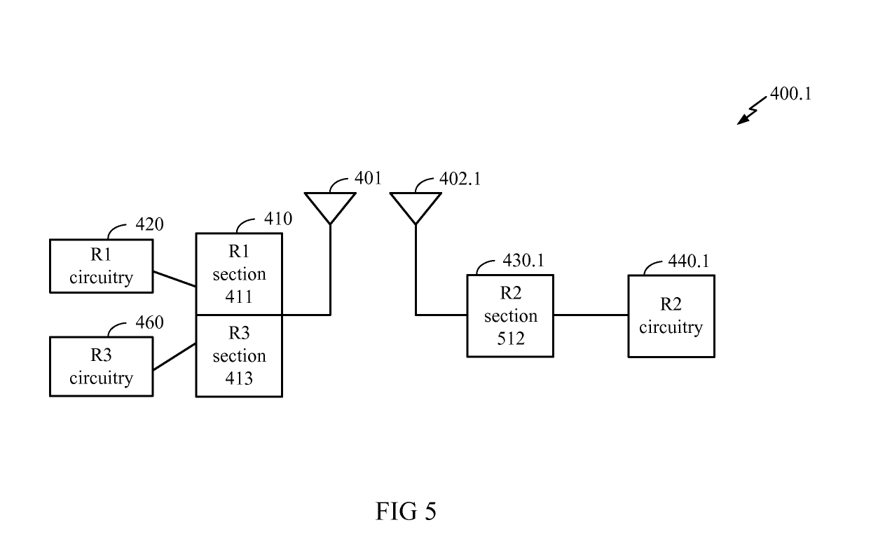

FIG. 5 illustrates an exemplary embodiment 400.1 of RF front end 400 wherein frequency selection block 430.1 accommodates a single range R2. Note FIG. 5 is shown for illustrative purposes only, and is not meant to limit the scope of the present disclosure to any particular exemplary embodiment shown.

In FIG. 5, note the processing of the three ranges R1, R2, R3 is effectively divided between two antennas, i.e., antenna 401 for R1, R3, and antenna 402.1 for R2. Antenna 402.1 is coupled to an exemplary embodiment 430.1 of frequency selection block 430, which includes a range selective section 512 that selects the single frequency range R2 for processing. Block 430.1 is coupled to R2-specific circuitry 440.1.

In an exemplary embodiment, range selective section 512 may be, e.g., a band-pass filter with passband covering R2. It will be appreciated that, as R2 lies between R1, R3, providing an antenna 402.1 for R2 separate from the antenna 401 for R1 and R3 advantageously relaxes the filter requirements for diplexer 410. In particular, as there is greater frequency separation between ranges R1 and R3 than, e.g., between R1 and R2, or between R2 and R3, the quality factor (Q) of filters within diplexer 410 may be lower by design, thus reducing cost.

A further advantage of the exemplary embodiment 400.1 is that, as antenna size is generally inversely proportional to the lowest frequency range the antenna needs to accommodate, antenna 402.1 (supporting a lowest frequency range of R2) may advantageously have physical dimensions smaller than antenna 401.

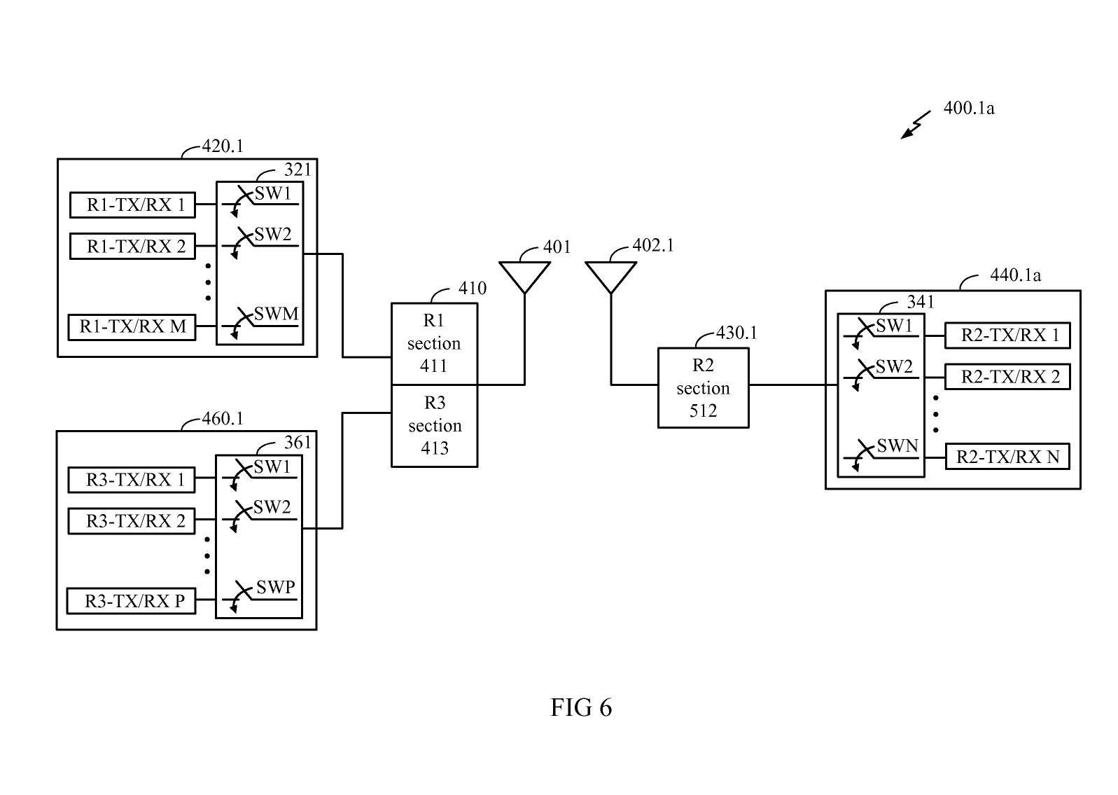

FIG. 6 further illustrates an exemplary embodiment 400.1a of RF front end 400.1 incorporating specific instances, 420.1, 460.1, and 440.1a of range-specific circuitry 420, 460, and 440, respectively. In particular, R2-specific circuitry 440.1a may include elements similar to those found in R2-specific circuitry 340, e.g., a multiple-throw switch module 341 coupled to a plurality N of transceiver blocks R2-TX/RX 1 through R2-TX/RX N, etc. It will be appreciated that the operating principles of range-specific circuitry 420.1, 460.1, and 440.1a will be clear in light of the description hereinabove with reference to range-specific circuitry 320, 340, or 360 in FIG. 3, and thus their description will be omitted hereinbelow.

Note FIG. 6 is shown for illustrative purposes only, and is not meant to limit the scope of the present disclosure to any particular exemplary embodiment of range-specific circuitry shown. Alternative exemplary embodiments of range-specific circuitry 440 may include, e.g., circuitry designed to process channels that are frequency-multiplexed, time-multiplexed, code-multiplexed, etc. Further note that while instances of channel-specific circuitry are shown as transceiver blocks, e.g., R1-TX/RX 1 or R2-TX/RX 1, in FIG. 4, channel-specific circuitry according to the present disclosure generally need not incorporate both receive and transmit functionalities. For example, in certain exemplary embodiments (not shown), any instance of channel-specific circuitry may incorporate only transmit functionality, or only receive functionality. Such alternative exemplary embodiments are contemplated to be within the scope of the present disclosure.

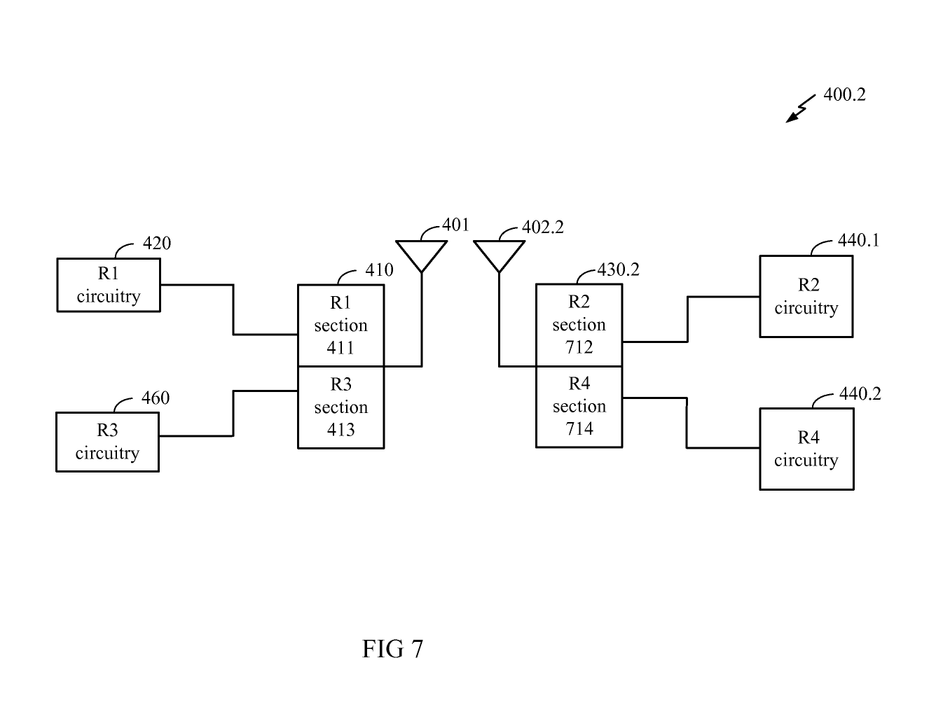

FIG. 7 illustrates an exemplary embodiment 400.2 of RF front end 400, wherein frequency selection block 430.2 accommodates both R2 and R4. Note FIG. 7 is shown for illustrative purposes only, and is not meant to limit the scope of the present disclosure to any particular exemplary embodiment shown.

In FIG. 7, antenna 402.2 is coupled to an exemplary embodiment 430.2 of frequency selection block 430. Antenna 402.2 may be designed to cover both R2 and R4, while frequency selection block 430.2 includes an R2-selective section 712 and an R4-selective section 714. In an exemplary embodiment, frequency selection block 430.2 may be, e.g., a diplexer accommodating both R2 and R4.

It will be appreciated that, as R4 is higher than R3, R2 and R4 are separated from each other by a range at least as wide as the bandwidth of R3. Accordingly, providing a dedicated antenna 402.2 for R2 and R4 separate from antenna 401 for R1 and R3 advantageously relaxes the requirements for frequency selection block 430.2, e.g., a diplexer associated with block 430.2. Furthermore, the physical size of antenna 402.2 is not expected to greatly exceed that of antenna 402.1 in FIG. 5, as R4 is much higher than R2, and thus the antenna portion supporting R4 is expected to consume much less physical area than the antenna portion supporting R2.

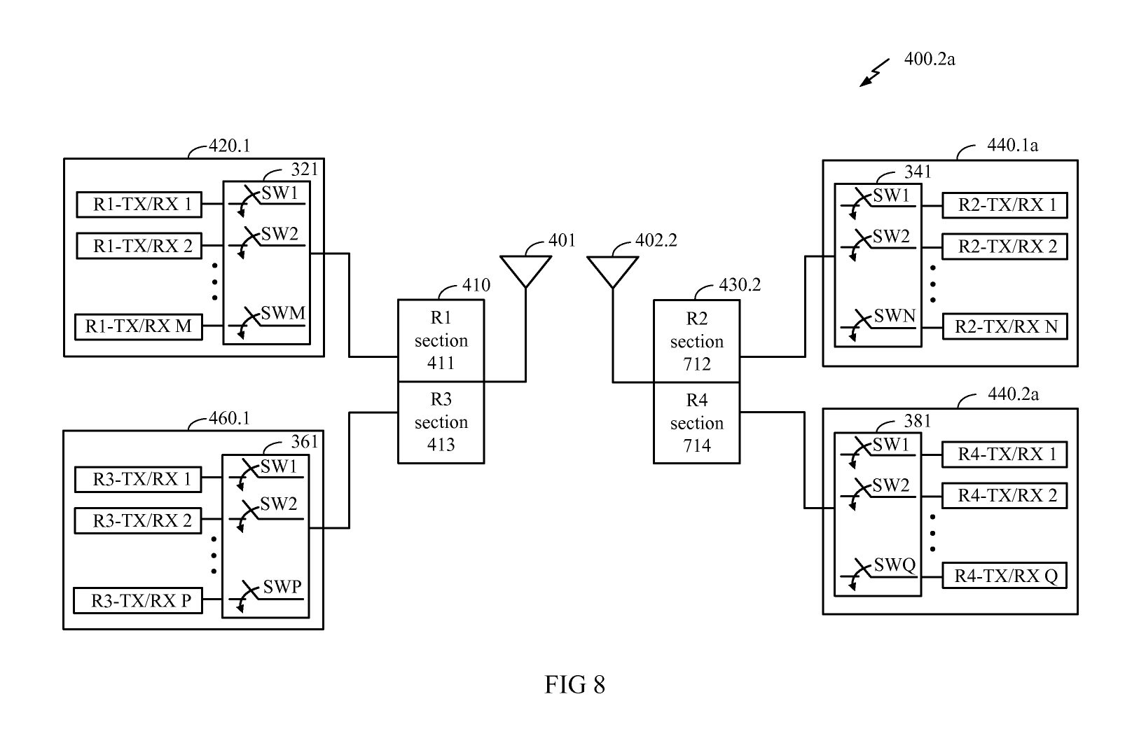

FIG. 8 illustrates an exemplary embodiment 400.2a of RF front end 400.2 incorporating specific instances 420.1, 460.1, 440.1a, and 440.2a of range-specific circuitry 420, 460, 440.1, and 440.2, respectively. It will be appreciated that the operating principles of the techniques applied to the range-specific circuitry of FIG. 8 will be clear in light of the description hereinabove with reference to FIGS. 3 and 6, and thus their description will be omitted hereinbelow.

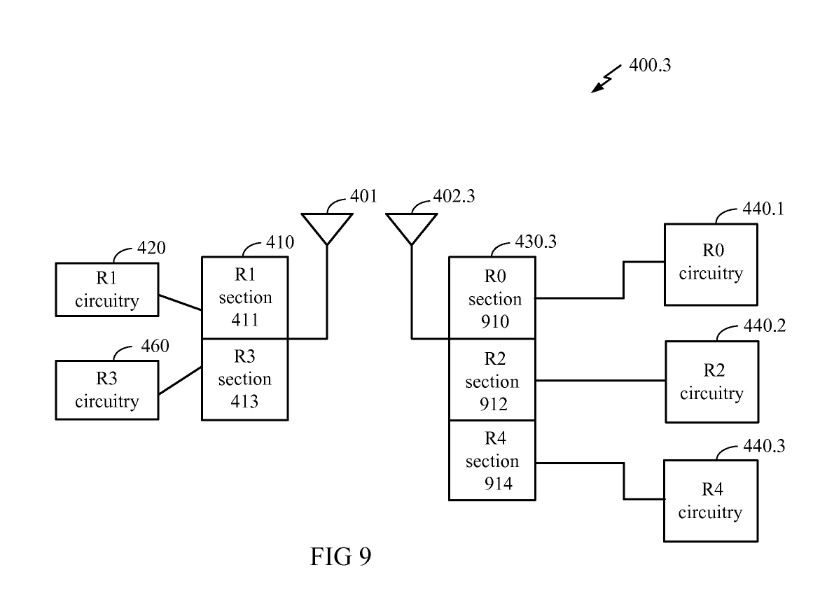

FIG. 9 illustrates an alternative exemplary embodiment 400.3 of RF front end 400 wherein frequency selection block 430.3 accommodates three ranges R0, R2, and R4. Note FIG. 9 is shown for illustrative purposes only, and is not meant to limit the scope of the present disclosure to any particular exemplary embodiment shown.

In FIG. 9, antenna 402.3 is coupled to an exemplary embodiment 430.3 of frequency selection block 430. Antenna 402.3 may be designed to cover R0, R2, and R4, while frequency selection block 430.3 includes an R0-selective section 910, an R2-selective section 912, and an R4-selective section 914. Sections 910, 912, 914 of block 430.3 are coupled to range-specific circuitry 440.1, 440.2, 440.3, respectively.

FIG. 10 illustrates an exemplary embodiment 1000 of a wireless device implementing the techniques of the present disclosure. Note FIG. 10 is shown for illustrative purposes only, and is not meant to limit the scope of the present disclosure. For example, alternative exemplary embodiments may accommodate less or more than the exemplary number of antennas shown. Such alternative exemplary embodiments are contemplated to be within the scope of the present disclosure.

In FIG. 10, wireless device 1000 includes a body 1010, on which is provided a circuit board 1020. The circuit board 1020 includes circuitry (not shown) for transmitting and receiving signals from a plurality of antennas 401.1, 401.2, 402.1, 402.2. In the exemplary embodiment shown, antennas 401.1 and 401.2 may each correspond to the antenna 401 in FIG. 4, e.g., accommodating R1 and R3, with respective circuitry coupled thereto (not shown in FIG. 10). Furthermore, antennas 402.1 and 402.2 may each correspond to the antenna 402 in FIG. 4, e.g., accommodating R0, R2, and/or R4, with respective circuitry coupled thereto (not shown in FIG. 10), as described hereinabove. For example, if antennas 402.1 and 402.2 each accommodate two ranges R2 and R4, then the wireless device 1000 may support the dual-antenna carrier aggregation feature for LTE over ranges R2 and R4.

In an exemplary embodiment, the respective frequency ranges R1, R2, etc., may be segmented by ratios. For example, f2 may correspond to 2* f1, etc. In an exemplary embodiment, R1 may correspond to a range from 699 MHz to 960 MHz, and R2 may correspond to a range from 1398 MHz to 1920 MHz. In an alternative exemplary embodiment, R2 may be restricted to correspond to a range from 1398 MHz to 1510 MHz, and R3 may correspond to a frequency range from 1710 MHz to above.

It will be appreciated that techniques of the present disclosure may be adapted to support 4-DL CA (i.e., 4-downlink carrier aggregation) and 2-UL CA (i.e., 2-uplink carrier aggregation) for the LTE standard, as well as exemplary embodiments supporting support 8-DL CA and 2-UL CA. Such schemes may support multiple carrier allocations that are, e.g., inter-band and/or intra-band. Techniques herein may further support 3-DL CA inter-band carrier aggregation. One of ordinary skill in the art will readily appreciate the proper segmentation of frequency ranges into R1, R2, R3, etc., based on the particular frequency allocations of each system. The techniques of the present disclosure described with reference to R1-R4 may readily be generalized to more than 4 or 5 frequency ranges, e.g., to support wireless devices supporting generalized N-DLCA and M-ULCA schemes according to the Advanced LTE standard, wherein N and M represent arbitrarily large numbers. Accordingly, advanced modern systems may be supported with four or more inter-band downlink carriers and one or more inter-band uplink carriers. It will further be appreciated that, in certain exemplary embodiments, the frequency ranges selected may be based on service provider specifications in the local wireless market areas.

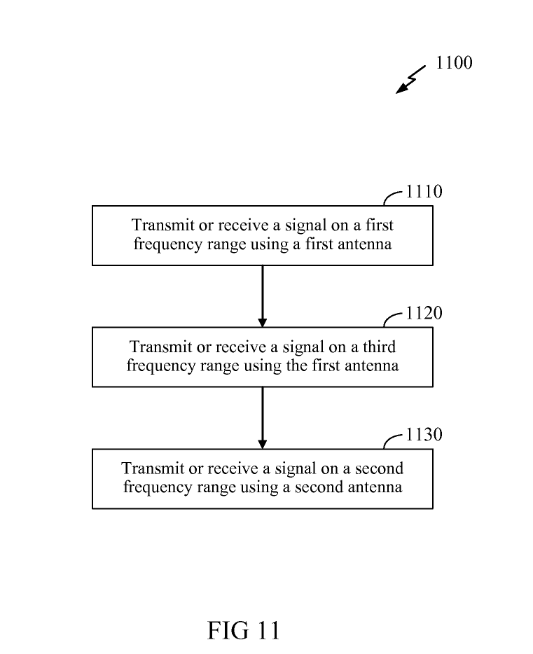

FIG. 11 illustrates an exemplary embodiment of a method 1100 according to the present disclosure. Note FIG. 11 is shown for illustrative purposes only, and is not meant to limit the scope of the present disclosure to any particular method shown.

In FIG. 11, at block 1110, a signal is transmitted or received on a first frequency range using a first antenna.

At block 1120, a signal is transmitted or received on a third frequency range using the first antenna.

At block 1130, a signal is transmitted or received on a second frequency range using a second antenna.

In an exemplary embodiment, the second frequency range lies between the first and third frequency ranges.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the exemplary aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary aspects of the invention.

The various illustrative logical blocks, modules, and circuits described in connection with the exemplary aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary aspects disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-Ray disc where disks usually reproduce data magnetically, while discs reproduce data optically with lasers. Combinations of the above should also be included within the scope of computer-readable media.

The previous description of the disclosed exemplary aspects is provided to enable any person skilled in the art to make or use the invention. Various modifications to these exemplary aspects will be readily apparent to those skilled in the art, and the generic principles defined herein may be applied to other exemplary aspects without departing from the spirit or scope of the invention. Thus, the present disclosure is not intended to be limited to the exemplary aspects shown herein but is to be accorded the widest scope consistent with the principles and novel features disclosed herein.

1. An apparatus comprising:
a first antenna configured to transmit or receive on a first frequency range, the first antenna further configured to transmit or receive on a third frequency range; and
a second antenna configured to transmit or receive on a second frequency range between the first and third frequency ranges.

2. The apparatus of claim 1, further comprising:
a first range selection block coupled to the first antenna, the first range selection block configured to process the first and third frequency ranges; and
a second range selection block coupled to the second antenna.

3. The apparatus of claim 2, further comprising:
first transceiver circuitry coupled to the first antenna for processing the first frequency range;
second transceiver circuitry coupled to the second antenna for processing the second frequency range; and
third transceiver circuitry coupled to the first antenna for processing the third frequency range.

4. The apparatus of claim 2, the first range selection block comprising a diplexer configured to select between the first and third frequency ranges.

5. The apparatus of claim 4, the second range selection block comprising a band-pass filter configured to select the second frequency range.

6. The apparatus of claim 1, the second antenna further configured to transmit or receive on a fourth frequency range higher than the third frequency range.

7. The apparatus of claim 6, further comprising:
a first range selection block coupled to the first antenna, the first range selection block configured to process the first and third frequency ranges; and
a second range selection block coupled to the second antenna, the second range selection block configured to process the second and fourth frequency ranges.

8. The apparatus of claim 7, further comprising:
first transceiver circuitry coupled to the first antenna for processing the first frequency range;
second transceiver circuitry coupled to the second antenna for processing the second frequency range;
third transceiver circuitry coupled to the first antenna for processing the third frequency range; and
fourth transceiver circuitry coupled to the second antenna for processing the fourth frequency range.

9. The apparatus of claim 1, further comprising:
a global positioning antenna (GPS) configured to receive on a frequency range associated with a GPS system.

10. The apparatus of claim 1, further configured to support a carrier aggregation feature according to the Long Term Evolution (LTE) standard, wherein at least two carriers correspond to different frequency ranges.

11. An apparatus comprising:
means for processing wireless signals on first and third frequency ranges; and
means for processing wireless signals on a second frequency range between the first and third frequency ranges.

12. The apparatus of claim 11, further comprising:
means for multiplexing and de-multiplexing signals on the first and third frequency ranges, said means coupled to the means for processing wireless signals on first and third frequency ranges.

13. The apparatus of claim 12, the means for processing wireless signals on the second frequency range further configured to process wireless signals on a fourth frequency range above the third frequency range, the apparatus further comprising:
means for multiplexing and de-multiplexing signals on the second and fourth frequency ranges, said means coupled to the means for processing wireless signals on second and fourth frequency ranges.

14. The apparatus of claim 12, further comprising means for processing the signals received on the separate frequency ranges according to a carrier aggregation scheme.

15. The apparatus of claim 11, further comprising means for implementing spatial diversity for each of the means for processing wireless signals on the first and third frequency ranges and the means for processing wireless signals on the second frequency range.

16. A method comprising:
transmitting or receiving a signal on a first frequency range using a first antenna;
transmitting or receiving a signal on a third frequency range using the first antenna; and
transmitting or receiving a signal on a second frequency range using a second antenna, the second frequency range lying between the first and third frequency ranges.

17. The method of claim 16, further comprising:
multiplexing or de-multiplexing signals on the first and third frequency ranges as transmitted or received using the first antenna.

18. The method of claim 17, further comprising:
transmitting or receiving wireless signals on a fourth frequency range above the third frequency range using the second antenna.

19. The method of claim 17, further comprising processing the signals received on the separate frequency ranges according to a carrier aggregation scheme.

20. The method of claim 17, further comprising transmitting or receiving wireless signals on each of the first, second, third, and fourth frequency ranges using first and second diversity antennas.
